(19) United States
(12) Patent Application Publication
(10) Pub. No.: US 2012/0001721 A1
(43) Pub. Date: Jan. 5, 2012

(54) THERMAL SWITCH

(75) Inventor: Hideaki Takeda, Misato (JP)

(73) Assignee: Uchiya Thermostat Co., Ltd., Misato (JP)

(21) Appl. No.: 13/254,698

(22) PCT Filed: Nov. 10, 2009
(86) PCT No.: PCT/JP2009/005986

§ 371 Date: Sep. 2, 2011

(30) Foreign Application Priority Data
Mar. 12, 2009 (JP) 2009-058836

(51) Int. Cl. H01H 37/04

(52) U.S. Cl. 337/372

(57) ABSTRACT

A movable plate 8 is partitioned by a slim hole 23 into a narrow-width part 21 and a wide-width part 22. When a contact is closed as a thermal switch 10, the narrow-width part 21 produces heat with an applied current branched via a first terminal 3 and a second terminal 4, which short-circuits both ends of the current limit resistor, and the heat of a bimetal 9 is retained with a small amount of local heat to self-hold the non-restoration state, so that the current limit resistor is quickly cooled down. When the power supply switch is turned off, the heat produced by the narrow-width part 21 is quickly cooled down to restore the thermal switch 10 in a short time. Also when the power supply is again turned on in a short time, the current limit resistor is made to function efficiently.

### TECHNICAL FIELD

The present invention relates to a thermal switch used in a power supply device for generating a direct-current voltage from an alternating-current power supply.

### BACKGROUND ART

Power supply devices for generating a predetermined direct-current voltage from an alternating-current power supply are known as conventional techniques. In such power supply devices, a smoothing circuit composed of a large-capacitance capacitor is normally provided on a downstream side of a rectifying element.

To the above described large-capacitance capacitor, a high current caused by an inrush current immediately after power is applied instantaneously flows. This current sometimes reaches approximately several tens of amperes (A) to 100 amperes depending on a condition.

If an inrush current is high as described above, significant ill effects of reducing the lifetime of a power supply switch or a rectifying diode are exerted.

To avoid such ill effects, a current of an output circuit is limited by arranging a current limit resistor in series on a downstream side of a power supply switch of a power supply device, so that an inrush current flowing into a rectifying diode or a capacitor when a power switch is turned on is reduced.

If a resistor used as a current limit resistor is a fixed resistor, a current loss becomes large. Therefore, a large NTC (Negative Temperature Coefficient) thermistor that has a low resistance and is called a power thermistor is used in many cases.

However, if a resistor is used in this way, a power loss in a resistor portion becomes large. Minimization of an energy loss in an electric appliance is a social challenge also from the viewpoint of recent environmental problems.

However, also the above described power loss caused by a current limit resistor in a power supply circuit is an important issue, and reducing the power loss caused by the current limit resistor has been studied as measures against such an issue.

For a current limit resistor, a method for preventing the current limit resistor from being burnt by produced heat, for example, by short-circuiting both ends of the current limit resistor with a relay after a power supply is turned on is proposed (for example, see Patent Document 1).

However, this method aims at preventing the current limit resistor from being burnt, and power is consumed to drive the relay. Therefore, this method is useless for an objective of reducing the power loss caused by the current limit resistor.

Additionally, to reduce an inrush current, a method for reducing the inrush current with a complicated circuit configuration is proposed (for example, see Patent Document 2).

With this method, however, the circuit configuration is complicated and cannot be incorporated in a small electronic appliance. In addition, the circuit configuration is used for a particular usage of applying power to a heater, and this is not normal.

Furthermore, an inrush current preventing device that can limit an inrush current even if a time interval from OFF to ON of a power supply switch is short is proposed to prevent the inrush current (for example, see Patent Document 3).

In this inrush current preventing device, a bimetal is used to short-circuit both ends of a current limit resistor, and a heatsink is used to quickly restore the bimetal switch after a power supply switch is turned off, leading to an increase in a device size, which is problematic.

Conventionally, the above described thermal switch of an OFF type at a normal temperature using a bimetal already exists. Such a thermal switch of an OFF type at a normal temperature has been used as a thermal switch for issuing warning by sensing a temperature rise, and for causing a circuit operation of stopping a temperature rise an electronic circuit to be performed.

If both ends of a current limit resistor are short-circuited by turning on the thermal switch of an OFF type at a normal temperature with a temperature rise in a current limit resistor, the current limit resistor stops producing heat. Therefore, a heat source for an ON operation of the thermal switch does not exist any more, and the temperature of the thermal switch goes down soon. As a result, the thermal switch is automatically restored to an OFF state.

If the thermal switch is restored to the OFF state when the power supply switch is ON and power is applied to an electric circuit, operations and restoration are repeated such that the current limit resistor restarts to produce heat and the thermal switch is again turned on to short-circuit both ends of the current limit resistor. Namely, a direct-current supplied from the power supply is pulsated, which is problematic.

However, if the thermal switch is configured as a non-restoration type, both the ends of the current limit resistor are left short-circuited, and a current limit does not function when the power supply is turned on next. Therefore, the thermal switch cannot be configured as a non-restoration type.

Accordingly, a power thermistor is used as a current limit resistor more often in order to prevent the current limit resistor from producing heat in a normal state of power application even after the thermal switch is restored to an OFF state.

### PRIOR ART DOCUMENTS

### Patent Documents

Patent Document 1: Japanese Laid-open Patent Publication No. 2004-080419

Patent Document 2: Japanese Laid-open Patent Publication No. 2005-274886

Patent Document 3: Japanese Laid-open Patent Publication No. 2004-133568

### SUMMARY OF THE INVENTION

### Problems to be Solved by the Invention

Incidentally, in a thermistor used as a current limit resistor, its resistance at a room temperature is approximately several Ω to 20Ω. After an inrush current is limited, the resistance is reduced to approximately one tenth of the resistance at the room temperature.

However, the thermistor still has the resistance of several Ω, which causes not only a power loss but a temperature rise of the thermistor itself. The temperature of the thermistor sometimes exceeds 150° C., which is not as high as a temperature of a normal resistor.

For example, if a heat source of 150° C. is included in a substrate of a power supply circuit where electronic components are densely populated, a safety problem occurs in the substrate of the power supply circuit.

### Means for solving the Problem

To overcome the above described problem, the present invention provides a thermal switch, connected in parallel with a current limit element of an electric circuit and operated by heat produced by the current limit element with a contact configuration that is OFF at a normal temperature, for short-circuiting both ends of the current limit element with a self-switch circuit by closing the contact. The thermal switch includes: a fixed conductor having a fixed contact provided at one end, and a first terminal for an external connection; an insulator, provided between the fixed contact and the first terminal of the fixed conductor, having columns integrally formed by being resin-molded; a resistive movable plate including a fixed part having holes into which the columns are inserted on the insulator, a movable contact that is formed in a position facing the fixed contact at an end on a side opposite to the fixed part and has a predetermined contact pressure, hooks for holding a bimetal respectively on a movable end side and a fixed end side, and a second terminal for an external connection; the bimetal, held by the hooks of the resistive movable plate, for opening/closing (the contact between?) the movable contact and the fixed contact by inverting a warpage direction at a predetermined temperature; and a resinous block for fixing the fixed part to the insulator by inserting the columns above the fixed part of the resistive movable plate having the holes into which the columns are inserted. In the thermal switch, the movable contact is separated from the fixed contact in a normal state, and a temperature of the bimetal is retained at a restoration temperature or higher with heat produced by the resistive movable plate with the use of an applied current branched to the self-switch circuit even if a temperature of the current limit resistor is lowered by the applied current branched to the current limit element and the self-switch circuit when power is supplied to the electric circuit, the current limit element produces heat with the applied current, the movable contact and the fixed contact are closed, and both the ends of the current limit element are short-circuited.

### Effect of the Invention

According to the present invention, both ends of a current limit resistor after an inrush current is limited are short-circuited to reduce a power loss and produced heat, which are caused by the current limit resistor, and moreover, heat is produced by applying a power supply current branched to the current limit resistor and a self-switch circuit to an included resistance part with short-circuiting of both the ends of the current limit resistor. As a result, the temperature of a bimetal in the self-switch circuit can be retained to a restoration temperature or higher with the heat produced by the self-switch circuit even though the temperature of the current limit resistor goes down after the inrush current is limited.

Additionally, pulsation of a direct current power supply is removed by resolving repetitions of useless operations and restoration, and at the same time, a power supply switch is quickly restored owing to a fast thermal response when being turned off. Accordingly, the current limit resistor can be made to function efficiently even though the power supply switch opens/closes at a short interval.

### BRIEF DESCRIPTION OF THE DRAWINGS

FIG. 1 is a side cross-sectional view of a thermal switch according to an embodiment 1 of the present invention;

FIG. 2 is an exploded perspective view of a structure of a thermal switch body part illustrated by removing a housing and a sealing member of the thermal switch according to the embodiment 1 of the present invention;

FIG. 3 illustrates an example of a power supply circuit of a power supply device for supplying a direct-current voltage from an alternating-current power supply that incorporates the thermal switch according to the embodiment 1 of the present invention;

FIG. 4 illustrates an example of using a thermistor in a power supply circuit of a power supply device for supplying a direct-current voltage from an alternating-current power supply that incorporates the thermal switch according to the embodiment 1 of the present invention;

FIG. 5 illustrates a relationship between an applied current and a lowered restoration temperature for movable plates that function as a resistance part of 0.2Ωor lower of the thermal switch according to the embodiment 1 of the present invention;

FIG. 6 is an exploded perspective view illustrating a configuration of a thermal switch according to an embodiment 2 of the present invention; and

FIG. 7 is an exploded perspective view illustrating a configuration of a thermal switch according to an embodiment 3 of the present invention.

### EXPLANATION OF THE CODES

1 thermal switch body part
2 housing
3 first terminal
4 second terminal
5 sealing member
6 fixed conductor
7 insulator
8 movable plate
9 bimetal
10 thermal switch
11 resinous block
12 fixed contact
13 columns
14 holes
15 fixed part
16 movable contact
17, 18 hooks
20 movable plate body part
21 narrow-width part
22 wide-width part
23 slim hole
24 protrusion
25 central part
26 penetration holes
27 level difference part
28 power supply switch
29 alternating-current power supply
31a, 31b wires
32 rectifying circuit
33a, 33b output wires
34 capacitor
35 fixed resistor
36 thermistor
37, 38 thermal switch
39 holes
40 fixed part
41, 42 external connection wires

### BEST MODE OF CARRYING OUT THE INVENTION

Embodiments according to the present invention are described in detail below.

### Embodiment 1

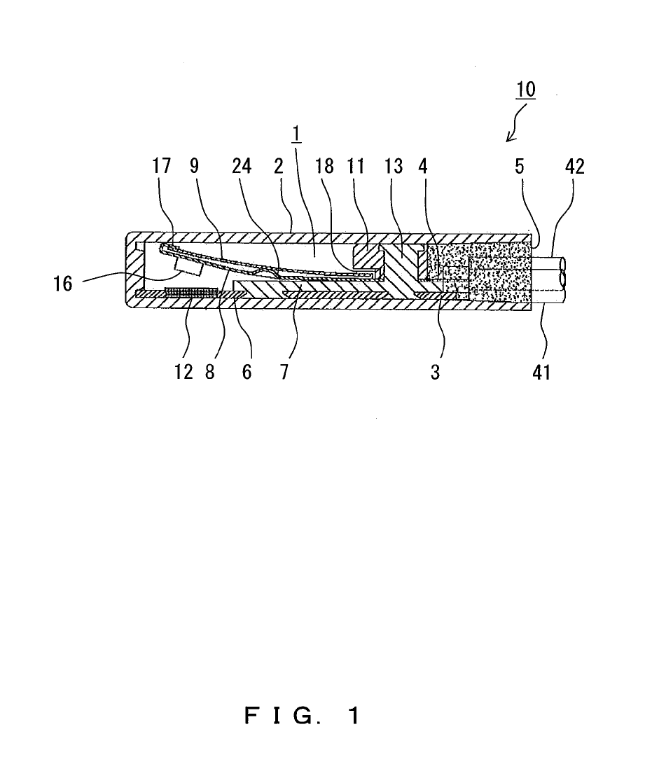

FIG. 1 is a side cross-sectional view of a thermal switch according to an embodiment 1. In the thermal switch 10 illustrated in FIG. 1, a thermal switch body part 1 is assembled within a parallel-piped insulative housing 2 having one surface that is open (the surface on the right side of FIG. 1).

The thermal switch body part 1 is sealed within the housing 2 by a sealing member 5, and a first terminal 3 and a second terminal 4 are terminals connected respectively to external connection wires 41 and 42.

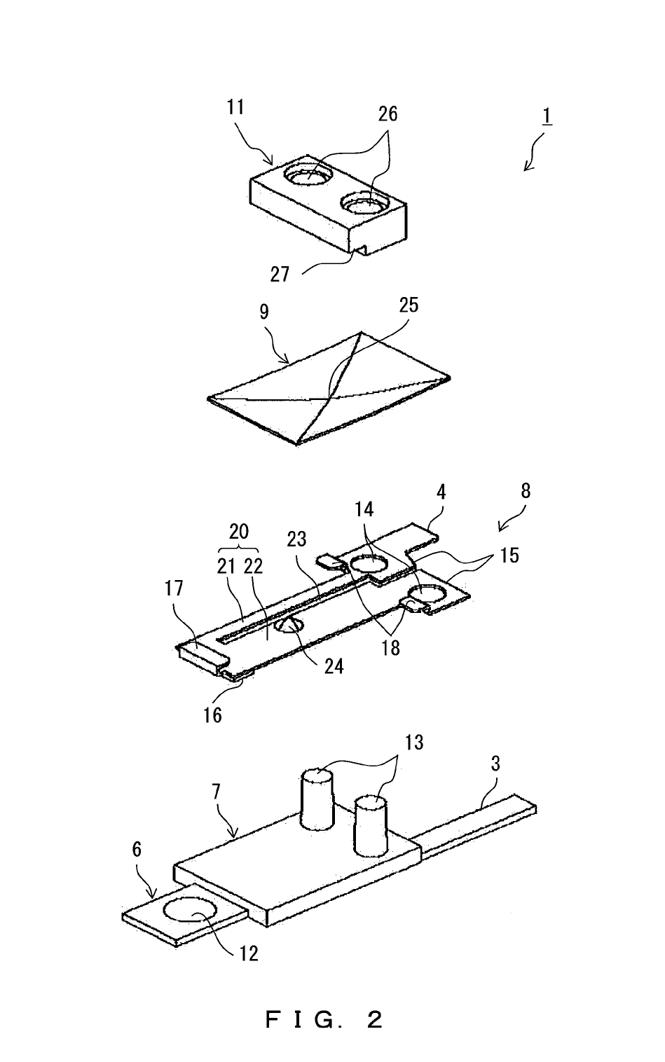

FIG. 2 is an exploded perspective view of a configuration of the thermal switch body part 1 illustrated by removing the housing 2 and the sealing member 5 of FIG. 1. A configuration of the thermal switch according to this embodiment is described with reference to FIGS. 1 and 2.

As illustrated in FIGS. 1 and 2, the thermal switch body part 1 is composed of a fixed conductor 6, an insulator 7, a movable plate 8, a bimetal 9 and a resinous block 11.

The fixed conductor 6 has a fixed contact 12 provided at one end, and a first terminal 3 provided at the other end. The insulator 7 is provided by being resin-molded between the fixed contact 12 and the first terminal 3 of the fixed conductor 6. The insulator 3 has two columns 13 that are integrally formed by being resin-molded.

The movable plate 4 has a fixed part 15 having holes 14 into which the columns 13 are inserted on the insulator 7. The movable plate 8 also has a movable contact 16 formed at an end on a side opposite to the fixed part 15. The movable contact 16 is formed in a position facing the fixed contact 12 of the fixed conductor 6.

The movable plate 8 further has one hook 17 and two hooks 18, which respectively hold the bimetal 9 on a movable end side provided with the movable contact 16 and a fixed end side provided with the fixed part 15.

Additionally, a slim hole 23, formed in a position closer to one (in the upwardly left direction in FIG. 1) of sides from a central line along the central line that links the movable contact 16 and the fixed part 15.

A movable plate body part 20 of the movable plate 8 is partitioned by the slim hole 23 into a narrow-width part 21 and a wide-width part 22 excluding the portion provided with the movable contact 16.

Additionally, on the movable plate 18, almost the center of the fixed part 15 is partitioned up to an end consecutively to the partitioned narrow-width part 21 and wide-width part 22.

To the movable plate 8, a second terminal 4 for an external connection is formed integrally with the end consecutive to the narrow-width part 21 of the fixed part 15 partitioned up to the end.

Moreover, on the wide-width part 22, a protrusion 24 is formed in a portion of almost the center of the movable plate body part 20.

The bimetal 9 is formed by drawing compound so that a central part 25 takes an upwardly concave shape at a normal temperature as illustrated in FIG. 2, and its warpage direction is inverted at a predetermined temperature higher than the normal temperature so that the central part 25 takes an upwardly convex shape.

The resinous block 11 has penetration holes 26 into which the columns 13 of the insulator 7 are inserted, and a level difference part 27 is formed at a bottom. The level difference part 27 serves as an escape part from the hooks 18 on the fixed end side of the movable plate 8 upon completion of the entire assembly.

To assemble the components illustrated in FIG. 1, the columns 13 of the insulator 7 are initially inserted into the holes 14 of the fixed part 15 of the movable plate 8. As a result, the movable plate 4 is assembled to the fixed conductor 6 where the central part is insulated with the insulator 7.

Then, both ends (the end in the lower left direction and the end in the upper right direction in FIG. 1) of the bimetal 9 are engaged with the one hook 17 and the two hooks 18 of the movable plate 8. As a result, the bimetal 9 is assembled to the movable plate 8.

Next, the columns 13 of the insulator 7 are inserted into the penetration holes 26 of the resinous block 11. Then, the fixed part 15 of the movable plate 8 is temporarily fixed to the insulator 7 by being pressed down by the resinous block 11.

Next, tips of the columns 13 made of resin are melted with a suitable heating member and hardened, so that the resinous block 11 is pressed down by the columns 13. In this way, the resinous block 11 is fixed to the insulator 7.

Here, the assembly of the thermal switch body part 1 is complete. The assembled thermal switch body part 1 is incorporated into the housing 2, an opening of which is then sealed with the sealing member 5 as illustrated in FIG. 1.

In this state, namely, in a normal state, the bimetal 9 lifts up the end, provided with the one hook 17, namely, provided with the movable contact 16 of the movable plate 8 according to the principle of leverage that uses the protrusion 24 and the two hooks 18 of the movable plate 8 respectively as a fulcrum and pressing portions.

As a result, a contact between the movable contact 16 and the fixed contact 12 is open in the normal state, so that power applied to an electric circuit formed between the first terminal 3 and the second terminal 4 is interrupted.

The bimetal 9 takes the upwardly concave shape at a room temperature as described above (see FIGS. 1 and 2). Then, the bimetal 9 inverts its warpage direction to take the upwardly convex shape in response to a change of an ambient temperature outside the thermal switch 10 to an inversion operation temperature specific to the bimetal 9 or higher.

The complete thermal switch 10 according to this embodiment that operates as described above and is illustrated in FIG. 1 is used for a power supply device for generating a direct-current voltage. When used, the thermal switch 10 is connected close to and in parallel with a current limit resistor for limiting an inrush current.

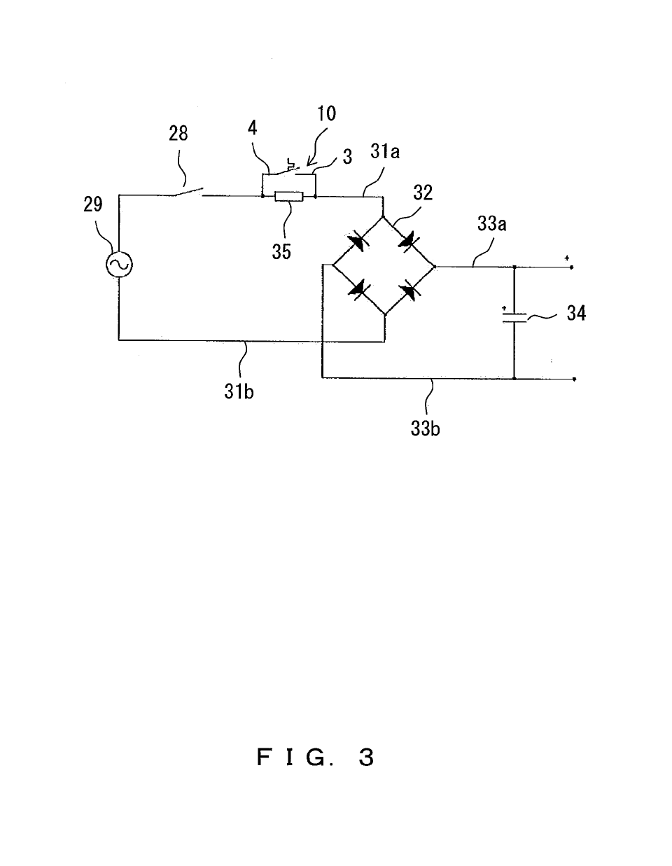

FIG. 3 illustrates an example where the thermal switch 10 according to this embodiment is incorporated in a power supply circuit of a normal power supply device for supplying a direct-current voltage from an alternating-current power supply.

In the power supply circuit illustrated in FIG. 3, a power supply switch 28 is closed, so that alternating-current power is input to a primary side of a rectifying circuit 32 via wires 31a and 31b from an alternating-current power supply 29.

The alternating-current voltage input to the primary side is rectified by diodes as rectifying elements of the rectifying circuit 32, and output from a secondary side via output wires 33a and 33b.

The direct-current voltage output from the secondary side is a pulsating voltage as it now stands. Therefore, the direct-current voltage is smoothed by a smoothing circuit of a capacitor 34 connected in parallel between the output wires 33a and 33b, and supplied to an external load from end terminal of the output wires 33a and 33b.

Here, in the example illustrated in FIG. 3, a fixed resistor 35 is connected in series to the wire 31a between the power supply switch 28 and the rectifying circuit 32, and the thermal switch 10 is connected in parallel with the fixed resistor 35.

In the circuit of the power supply device illustrated in FIG. 3, the emptied capacitor 34 is charged at the moment when the power supply switch 28 is turned on. When the capacitor 34 is charged, a very high charge current flows depending on the timing of turning on the power supply switch 29, namely, a switching phase angle of the alternating-current power supply 29, and the capacitance of the capacitor 34.

If such a very high charge current flows, it can possibly exceed the highest current rating of the diodes of the rectifying circuit 32, the contact rating of the power supply switch 28, or a maximum condition of the capacitor 34.

If a current that exceeds the maximum condition or the rating flows as described above, this can lead to a fault of a component. To prevent such a fault from occurring, the fixed resistor 35 is inserted in the circuit in series as a current limit resistor. The circuit is configured so that the highest current is limited by the fixed resistor 35.

In the meantime, even with a rated current after the highest current is limited, a power loss and produced heat, which are caused by the resistance of the fixed resistor 35, cannot be avoided.

To reduce the power loss and the produced heat, both ends of the fixed resistor 35 after the highest current is limited is short-circuited with the thermal switch 10 in this embodiment.

Namely, as illustrated in FIG. 3, the thermal switch 10 according to the embodiment 1 illustrated in FIGS. 1 and 2 is arranged close to the fixed resistor 35 and coupled in parallel with the fixed resistor 35.

The thermal switch 10 is operated with heat produced by the fixed resistor 35 when the highest current is limited. Namely, the contact between the fixed contact 12 and the movable contact 16 is closed by inverting the bimetal 9 to take the upwardly convex shape.

As a result, power is applied to the first terminal 3 and the second terminal 4, so that both the ends of the fixed resistor 35 are short-circuited. As a result of this short-circuiting, the current that flows into the fixed resistor 35 is branched to the side of the thermal switch 10. With this branched current, the narrow-width part 21 of the movable plate 8 produces Joule heat.

This Joule heat is locally generated heat. However, this is heat that heats up the movable plate body part 20 and is produced in a position extremely close to the bimetal 9. Therefore, this Joule heat retains the heat of the bimetal 9 after the contact is closed.

As a result, the bimetal 9 is prevented from being restored to the original state illustrated in FIGS. 1 and 2, and the bimetal 9 is enabled to perform a so-called self-holding operation.

More specifically, the heat of the bimetal 9 is retained even though an ambient temperature goes down from the original restoration temperature, namely, the restoration temperature at the time of no applied power of the bimetal 9 when a load current is applied.

Accordingly, the bimetal 9 is not restored unless the ambient temperature becomes lower than the original restoration temperature of the bimetal 9 by a temperature for the heat retention.

As a result, the bimetal 9 can perform a self-holding operation in a non-restoration state (a state where both the ends of the fixed resistor 35 are short-circuited by closing the contact).

In addition, since the current is branched to the side of the thermal switch 10, the fixed resistor 35 that is a heat source for operating the thermal switch 10 stops producing heat, and the temperature of the fixed resister 35 is lowered to the ambient temperature.

As described above, the heat retention for the self-holding operation of the thermal switch 10 is made by heat locally produced inside. Therefore, after the power supply switch 28 at the source is turned off, the bimetal 9 is quickly cooled down, and at the same time, the restoration time as the thermal switch 10 is shortened.

Additionally, by setting, to a large value, a difference between the ambient temperature and the original restoration temperature of the bimetal 9, the bimetal 9 is quickly cooled down after the power supply switch at the source is turned off, and the restoration time of the thermal switch 10 can be shortened also in this case.

The reason why the bimetal 9 is quickly cooled down to the ambient temperature when the power supply switch is turned off is as follows: the heat source for retaining the heat of the bimetal 9 is the narrow-width part 21 that is only a small portion of the movable plate 8, has a small thermal capacity, and produces a small amount of heat.

Normally, there may be cases where a power supply is again turned on in a short time after once turned off. Also in such cases, the current limit function implemented by the fixed resistor 35 can be operated by quickly restoring the thermal switch 10, namely, by quickly opening a branched path of an current as described above when the power supply is turned off, even if the power supply is again turned on in a short time after turned off.

If the power supply is again turned on in such an extremely shorter time than the restoration of the thermal switch 10, a high inrush current is not generated because a charge of the capacitor 23 remains. Therefore, this is not problematic.

Additionally, a power supply switch normally has a contact switch in terms of an electric circuit. Therefore, it is preferable to control ON/OFF of a power supply on an alternating-current side.

Accordingly, it is safe to incorporate the fixed resistor 35 for limiting a current into the power supply side, namely, the primary side of the rectifying circuit 32.

Also if the fixed resistor 35 and the thermal switch 10 are arranged in a direct-current circuit, the thermal switch 10 is connected to both the ends of the fixed resistor 35. Therefore, the entire power supply voltage is not applied to the thermal switch 10.

Accordingly, with a power supply voltage up to approximately 24V, a problem does not normally occur in the interrupt of a contact current when the thermal switch 10 is restored.

As described above, by using the thermal switch 10 according to the embodiment 1 in parallel with the current limit resistor of the power supply device, a power loss and produced heat, which are caused by the resistance of the current limit resistor (the fixed resistor 35), can be reduced with the configuration less expensive and simpler than an expensive short-circuit mechanism for both the ends of a conventional current limit resistor using a relay.

Additionally, by similarly using the thermal switch 10 according to the embodiment 1 in parallel with the current limit resistor of the power supply device, pulsation caused by repetitions of operations and restoration of a normal thermal switch in a direct current supplied from the power supply can be removed.

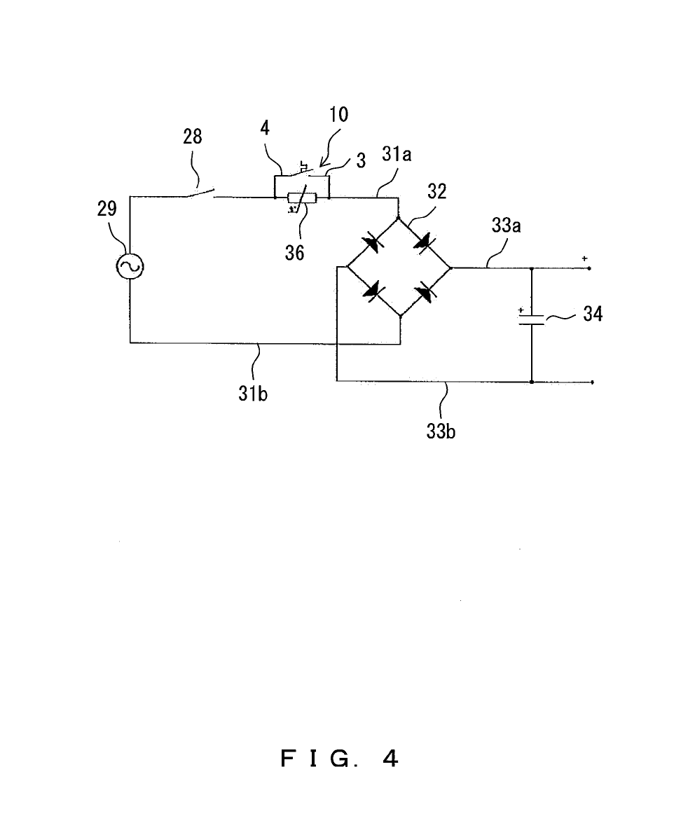

FIG. 4 illustrates an example where a thermistor 36 is used as a current limit resistor inserted in a power supply circuit of a power supply device for supplying a direct-current voltage from an alternating-current power supply. The same components in FIG. 4 as those of FIG. 3 are denoted with the same reference numerals as those of FIG. 3.

Depending on the size of a circuit current, the current limit resistor produces heat as described above. Therefore, also the thermistor 36 of FIG. 4, which has a resistance that increases to limit a current only when a power supply is turned on and decreases in a stable state, is used as a current limit resistor.

For the thermistor 36, its resistance decreases and voltages at both ends go down when a rated current is applied.

Therefore, no problems occur when the current is interrupted to restore the thermal switch 10. Also in this case, operations of the thermal switch 10 according to the embodiment 1 are similar to those of FIG. 3.

Here, an original restoration temperature after the thermal switch 10 operates, namely, the restoration temperature (referred to as a restoration temperature with no applied power here) with a current approximately as high as a signal current for verifying a contact state is described. This restoration temperature may be set to be higher than an ambient temperature.

After the capacitor 34 is fully charged with a current limited by the current limit resistor (the fixed resistor 35 or the thermistor 36. The same applies hereinafter), a current consumed in the circuit continuously flows.

In the current limit resistor, Joule heat expressed by a value obtained by multiplying the square of the current by a resistance value at that time, namely, expressed by power is generated.

When the thermal switch 10 is operated with the heat of the current limit resistor, most of the current is branched to the side of the thermal switch 10, and the temperature of the current limit resistor goes down and reaches the ambient temperature soon.

A resistance value set for the resistance part of the above described narrow-width part 21 of the movable plate 8 needs to be adjusted depending on a current or temperature condition. With an actual measurement, the resistance of the narrow-width part 21 is approximately one tenth of the resistance of the thermistor 36 in the state of producing heat, and functions as the resistance part of approximately 0.2Ω or lower.

In one example, the restoration temperature when a current of 2A is applied can be lowered by 45° C. with the movable plate 8 of 0.2Ω.

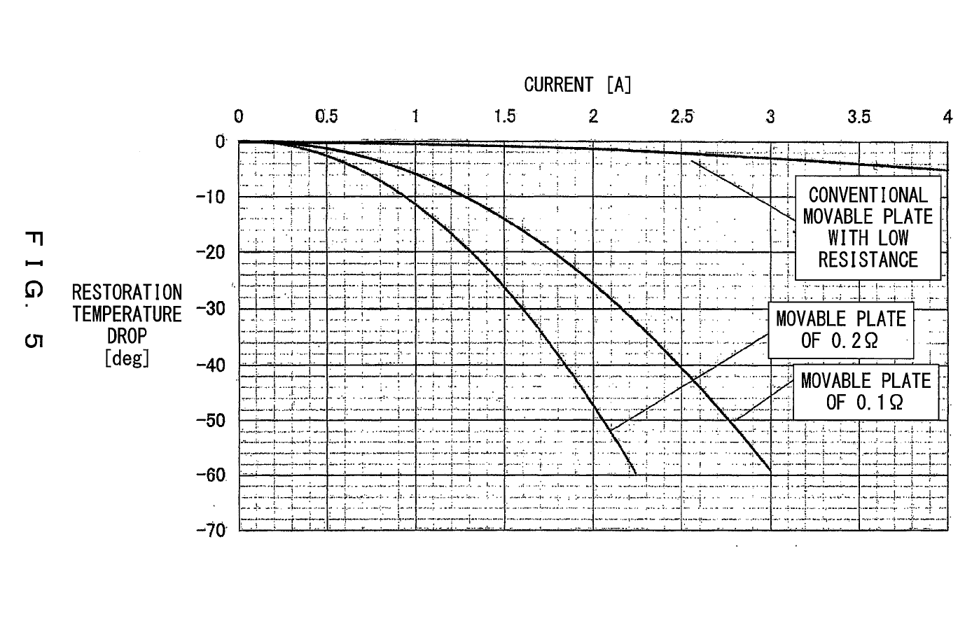

FIG. 5 illustrates a relationship between an applied current (A) and a lowered restoration temperature for movable plates that function as the resistance part of 0.2Ω or lower.

Compared with a conventional low-resistance movable plate in the case of the same applied current of 2A (amperes), the restoration temperature of the thermal switch 10 when a low-resistance movable plate 8 of 0.2Ω is used for the thermal switch 10 according to the embodiment 1 is proved to go down by 25° C. or more, and the restoration temperature of the thermal switch 10 when a low-resistance movable plate 8 of 0.1Ω is used for the thermal switch 10 according to the embodiment 1 is proved to go down by 46° C. or more.

Here, assuming that the operation temperature of the thermal switch 10 is 90° C. or approximately 100° C., the restoration temperature is approximately 70° C.

Since there is a temperature difference between the restoration temperature of 70° C. and the room temperature of 25° C., a thermal switch having a restoration temperature of 70° C. can be restored at the room temperature of 25° C. if the restoration temperature can be lowered by 45° C.

Additionally, assuming that the upper limit of an environmental temperature of the power supply is 50° C., the thermal switch having the restoration temperature of 70° C. can be restored at the upper limit 50° C. of the environment temperature of the power supply if the restoration temperature can be lowered by 20° C.

These conditions are determined based on conditions such as the resistance value of the movable plate 8, the restoration temperature of the bimetal 9, the size of an applied current and the like on the side of the thermal protector 10, whereas these conditions are determined based on a temperature condition, a current condition and the like on the side of the power supply.

By suitably setting a cross-sectional area of the narrow-width part 21 in the configuration of the embodiment 1, the narrow-width part 21 can be configured to be melted when an excessive current flows in the power supply while the thermal switch 10 is operating.

In the event that the thermal switch 10 is restored with a delay, the capacitor 34 is quickly discharged and the power supply is again turned on in a short time when the power supply switch is turned off, an excessive inrush current flows.

By configuring the narrow-width part 21 to be melted with this excessive inrush current as described above, the components of the circuit can be protected with the current limit resistor from being damaged by the inrush current.

In this case, the thermal switch 10 where the narrow-width part 21 is melted may be replaced with a new thermal switch when a maintenance operation for restoring the circuit by finding the cause of the accident is performed.

With the above described configuration of the thermal switch 10 according to this embodiment, a power loss caused by the current limit resistor can be reduced when the thermal switch 10 is coupled in parallel with the current limit resistor of the power supply device.

Additionally, the internal resistance is approximately one tenth of a high-temperature resistance of a thermistor. Therefore, the power loss can be further reduced to one tenth or less compared with the thermistor.

Furthermore, the thermal switch 10 can perform a self-holding operation until restored only with an applied current without needing an energy source additionally arranged, thereby implementing a cost-effective thermal switch with a simple configuration.

Still further, various self-holding conditions can be set by combining the settings of an applied current, an internal resistance settable with the narrow-width part, and a restoration temperature, so that a widely applicable thermal switch can be provided without changing the whole size.

### Embodiment 2

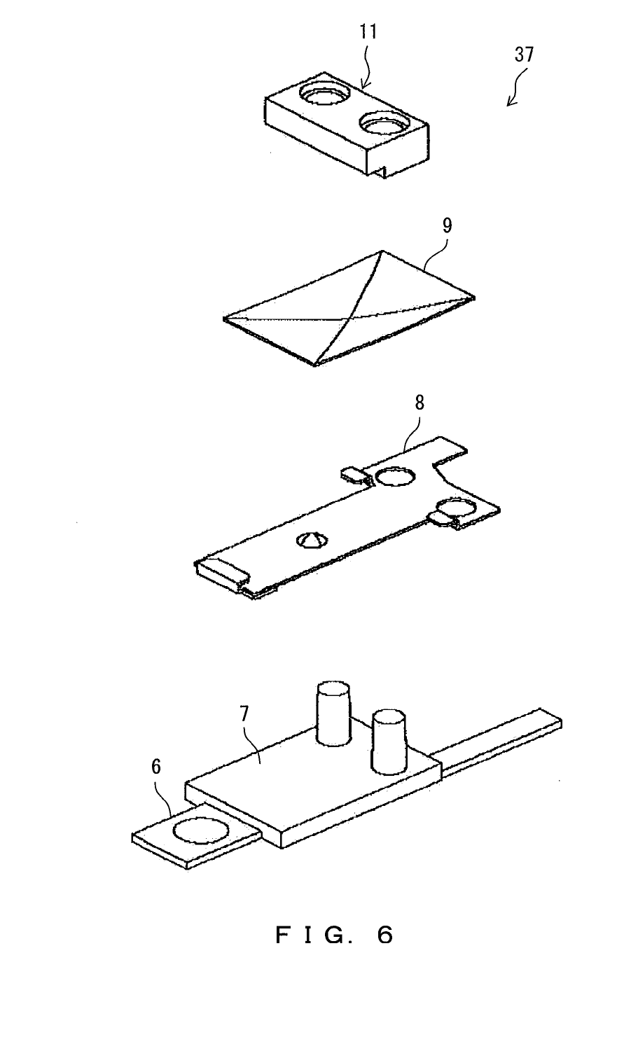

FIG. 6 is an exploded perspective view illustrating a configuration of a thermal switch according to an embodiment 2. The same components or functions of FIG. 6 as those of FIG. 2 are denoted with a minimum number of the same reference numerals, needed for descriptions, as those of FIG. 2.

Unlike the thermal switch 10 illustrated in FIG. 2, the thermal switch 37 illustrated in FIG. 6 is one plate implemented without partitioning the movable plate 8 into the narrow-width part and the wide-width part.

Even a movable plate in such a shape can be used as a resistive movable plate, namely, a heat-producing resistor by selecting a material with a low conductivity as the material of the movable plate and by increasing an electric resistance, and settings similar to those in the case of the embodiment 1 can be made depending on a current to be processed.

Note that the movable plate may be implemented as a normal movable plate, and a resistor may be further incorporated in addition to the movable plate.

### Embodiment 3

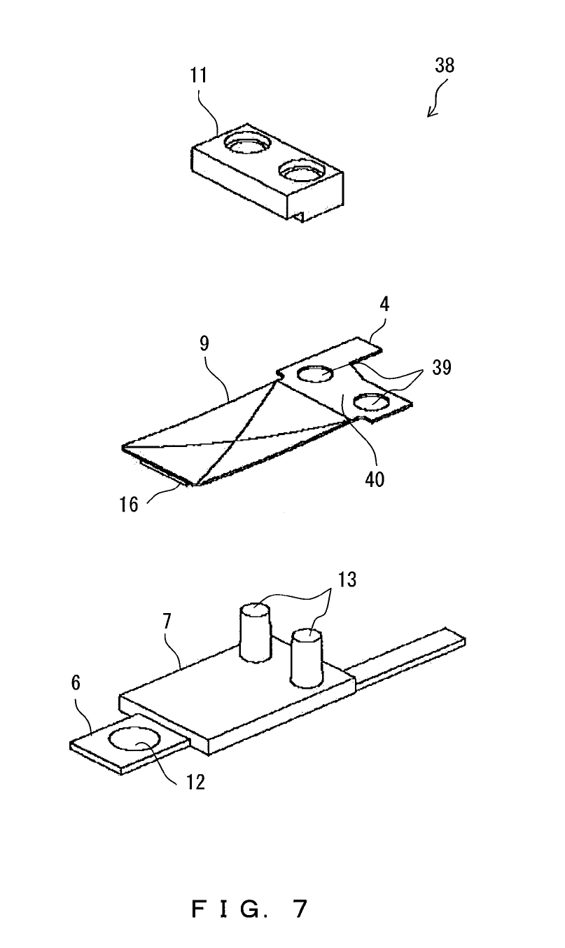

FIG. 7 is an exploded perspective view illustrating a configuration of a thermal switch according to an embodiment 3. The same components and functions of FIG. 7 as those of FIG. 2 are denoted with a minimum number of the same reference numerals, needed for descriptions, as those of FIG. 2.

In the thermal switch 38 according to this embodiment, the movable plate 8 of FIG. 2 or 6 is removed, and a bimetal 9 serves as a movable plate, a resistor and a bimetal. Namely, the thermal switch 38 according to this embodiment is an example of a configuration for directly applying a current to the bimetal 9.

The bimetal 9 in this embodiment has a fixed part 40 provided with holes 39 into which the columns 13 are inserted on the insulator 7.

Moreover, the bimetal 9 has a second terminal 4, formed in the fixed part 40, for an external connection, and also has a movable contact 16 formed in a position facing the fixed contact 12 of the fixed conductor 6 at an end on a side opposite to the fixed part 40.

Since the bimetal itself is originally made of a material with a low conductivity, it preferably serves also as a high resistor. This bimetal sufficiently functions as a resistor for operating the bimetal itself depending on a current value of a circuit to be processed in a similar as in the case of the embodiment 1.

### INDUSTRIAL APPLICABILITY

The present invention is applicable to a thermal switch that branches a power supply current to a current limit resistor and a self-switch circuit by short-circuiting both ends of the current limit resistor after an inrush current is limited, reduces a power loss caused by the current limit resistor as much as possible, removes pulsation of a direct current caused by repetitions of operations and restoration, and makes the current limit resistor function efficiently even if a power supply switch opens/closes at a short interval.

1. A thermal switch, connected in parallel with a current limit element of an electric circuit and operated by heat produced by the current limit element with a contact configuration that is OFF at a normal temperature, for short-circuiting both ends of the current limit element with a self-switch circuit by closing the contact, comprising:
a fixed conductor having a fixed contact provided at one end, and a first terminal for an external connection;
an insulator, provided between the fixed contact and the first terminal of the fixed conductor, having columns integrally formed by being resin-molded;
a resistive movable plate comprising
a fixed part having holes into which the columns are inserted on the insulator,
a movable contact that is formed in a position facing the fixed contact at an end on a side opposite to the fixed part and has a predetermined contact pressure,
hooks for holding a bimetal respectively on a movable end side and a fixed end side, and
a second terminal for an external connection;
the bimetal, held by the hooks of the resistive movable plate, for opening/closing the movable contact and the fixed contact by inverting a warpage direction at a predetermined temperature; and
a resinous block for fixing the fixed part to the insulator by inserting the columns above the fixed part of the resistive movable plate having the holes into which the columns are inserted, wherein
the movable contact is separated from the fixed contact in a normal state, and
a temperature of the bimetal is retained at a restoration temperature or higher with heat produced by the resistive movable plate with the use of an applied current branched to the self-switch circuit even if a temperature of the current limit resistor is lowered by the applied current branched to the current limit element and the self-switch circuit when power is supplied to the electric circuit, the current limit element produces heat with the applied current, the movable contact and the fixed contact are closed, and both ends of the current limit element are short-circuited.

2. The thermal switch according to claim 1, wherein
the current limit element is a fixed resistor.

3. The thermal switch according to claim 1, wherein
the current limit element is an NTC (Negative Temperature Coefficient) thermistor.

4. The thermal switch according to claim 1, wherein
the restoration temperature is set to a temperature higher than an upper limit of an ambient temperature of a thermal switch body part at least by 10° C., and the temperature of the bimetal is retained with heat produced by a narrow-width part with the use of the applied current so that the temperature of the bimetal becomes a restoration temperature equal to or lower than at least a room temperature in a state where power is applied after the contact is closed.

5. The thermal switch according to claim 1, wherein
the restoration temperature when a rated current is applied is lowered by 20° C. or more than the restoration temperature at the time of no applied power.

6. The thermal switch according to claim 1, wherein
the electric circuit is a power supply output circuit of a power supply device for converting from an alternating current into a direct current.

7. The thermal switch according to claim 1, wherein
the electric circuit is a direct-current circuit including a voltage exceeding 24V, and
voltages at both the ends of the current limit circuit are equal to or lower than 24V.

8. The thermal switch according to claim 1, wherein
when an excessive current exceeding a predetermined overcurrent flows, a narrow-width part of the movable plate is melted.

9. The thermal switch according to claim 1, wherein
the resistive movable plate is configured with a plate member made of stainless steel.

10. The thermal switch according to claim 1, wherein:
the movable plate comprises
a slim hole, formed by being cut from the fixed part toward the movable contact in a position closer to one of sides from a central line along the central line that links the movable contact and the fixed part, for partitioning the movable plate into a wide-width part and a narrow-width part, and for further partitioning the fixed part up to an end consecutively to the partitioning, and
a second terminal, connected to the end consecutive to the narrow-width part of the fixed part partitioned up to the end, for an external connection;
the movable plate has a structural resistance formed by the narrow-width part;
the movable contact is separated from the fixed contact in the normal state; and
a temperature of the bimetal is kept at a restoration temperature or higher with heat produced by the structural resistance formed by the narrow-width part with the use of an applied current branched to the self-switch circuit even if a temperature of the current limit resistor is lowered by the applied current branched to the current limit element and the self-switch circuit when power is supplied to the electric circuit, the current limit element produces heat with the applied current, the movable contact and the fixed contact are closed and both the ends of the current limit element are short-circuited.
